(19) United States
(12) Patent Application Publication
(10) Pub. No.: US 2022/0221290 A1
(43) Pub. Date: Jul. 14, 2022

(54) ROUTE DATA CONVERSION METHOD, NON-TRANSITORY COMPUTER-READABLE STORAGE MEDIUM, AND ROUTE DATA CONVERSION DEVICE

(71) Applicant: HONDA MOTOR CO., LTD., Tokyo (JP)

(72) Inventors: Hidetoshi CHIKAMORI, Saitama (JP); Kazumasa NAKAMURA, Saitama (JP); Hitoshi KONISHI, Saitama (JP); Takuji HARAYAMA, Saitama (JP); Tomoaki MASAKAWA, Tokyo (JP); Naofumi ASO, Saitama (JP); Ryo MATSUZAWA, Tokyo (JP); Zhaoqi WANG, Tokyo (JP)

(21) Appl. No.: 17/573,133

(22) Filed: Jan. 11, 2022

(30) Foreign Application Priority Data
Jan. 12, 2021 (JP) 2021-002811

(51) Int. Cl. G01C 21/34; G01C 21/00

(52) U.S. Cl. CPC G01C 21/3461; G01C 21/3484; G01C 21/3885; G01C 21/387

(57) ABSTRACT

A route data conversion method is used for acquiring a second route on a second map that matches a first route on a first map. The first route is expressed as route nodes and route links, the route nodes being defined by latitude, longitude, and altitude, the route links connecting the route nodes. The second map includes a lane expressed as lane nodes and lane links, the lane nodes being defined by the latitude, longitude, and altitude, the lane links connecting the lane nodes. The route data conversion method includes: extracting the lane nodes whose latitude, longitude, and altitude match the latitude, longitude, and altitude of the route nodes respectively; and acquiring the second route by connecting the extracted lane nodes by the lane links.

### TECHNICAL FIELD

The present invention relates to a route data conversion method, a non-transitory computer-readable storage medium, and a route data conversion device for acquiring a second route on a second map that matches a first route on a first map so as to link the second route with the first route.

### BACKGROUND ART

A known vehicle control system creates an action plan for autonomous driving based on a route determined by a navigation device based on map data (hereinafter referred to as “the navigation map”) and map data (hereinafter referred to as “the high-precision map”) including more detailed information than the map data stored in the navigation device (for example, JP2017-7572A). The vehicle control system disclosed in JP2017-7572A compares the informational freshness of the navigation map with that of the high-precision map based on versions and road shapes, and determines that the autonomous driving can be executed in a case where the informational freshness of the navigation map matches that of the high-precision map.

Vehicle control in the autonomous driving requires more information on a road than the navigation map, and thus is executed based on the high-precision map, which includes more information on the road. However, a route to a destination is determined by the navigation device as a route on a map. Accordingly, so as to execute the autonomous driving along the route to the destination, a technique for acquiring route data on the high-precision map that matches route data determined by the navigation device is required (that is, a technique for linking the navigation map with the high-precision map is required).

The navigation map often does not completely match the high-precision map because the companies that provide the above maps have different criteria for selecting roads, so that the route data on the navigation device cannot be simply converted into the route data on the high-precision map. For example, in a case where a route on the navigation map (the first map) passes through multi-level crossing roads (that is, roads crossing on multiple levels), it is not easy to convert the route on the navigation map (the first map) into a route on the high-precision map (the second map) that matches the route on the navigation map, since it is necessary to determine which one of the multi-level crossing roads the route on the navigation map passes through.

### SUMMARY OF THE INVENTION

In view of the above background, an object of the present invention is to provide a route data conversion method, a non-transitory computer-readable storage medium, and a route data conversion device for acquiring a second route on a second map that matches a first route on a first map, more specifically, for acquiring an appropriate second route even if a first route is passing through multi-level crossing roads.

To achieve such an object, one aspect of the present invention provides a route data conversion method for acquiring a second route (S) on a second map that matches a first route (R) on a first map, the first route being expressed as route nodes (N) and route links (M), the route nodes being defined by latitude, longitude, and altitude, the route links connecting the route nodes, the second map including a lane expressed as lane nodes (C) and lane links (D), the lane nodes being defined by the latitude, longitude, and altitude, the lane links connecting the lane nodes, the route data conversion method comprising: extracting the lane nodes whose latitude, longitude, and altitude match the latitude, longitude, and altitude of the route nodes respectively (step ST1 and step ST15); and acquiring the second route by connecting the extracted lane nodes by the lane links (step ST3 and step ST16).

According to this aspect, the lane nodes that match the route nodes with respect to the altitude are extracted, and thus the second route is acquired. Accordingly, even if the first route passes through multi-level crossing roads, it is possible to substantially determine which one of the multi-level crossing roads the first route passes through based on the altitude, so that an appropriate second route can be acquired.

In the above aspect, preferably, in the step of extracting the lane nodes, extracting areas (Pc) containing the route nodes from an intermediate map including the areas (P) centered on the lane nodes and area links (Q) connecting the areas, thereby extracting the lane nodes whose latitude, longitude, and altitude match the latitude, longitude, and altitude of the route nodes respectively.

According to this aspect, even if the route nodes on the first map do not completely match the lane nodes on the second map, it is possible to extract the lane nodes that match the route nodes.

In the above aspect, preferably, each of the areas is defined by a prescribed longitudinal range, latitudinal range, and altitudinal range centered on the lane node.

According to this aspect, it is possible to easily set the areas for extracting the lane nodes that match the route nodes.

In the above aspect, preferably, an altitudinal length of each of the areas is smaller than an altitudinal difference between two roads crossing on multiple levels.

According to this aspect, it is possible to reliably determine which one of the multi-level crossing roads (that is, the roads crossing on multiple levels) the first route passes through. Accordingly, even if the first route passes through the multi-level crossing roads, it is possible to more reliably acquire the second route on the second map that matches the first route on the first map.

In the above aspect, preferably, the first map includes image data (G) showing a plan view of a road, and in the step of extracting the lane nodes, acquiring road areas (J) based on the image data and the route nodes such that the road areas contain the route nodes and match not only a shape of the road through which the first route passes but also the altitude of the route nodes in the plan view, and extracting the lane nodes that match the road areas.

According to this aspect, the road areas are set based on the image data showing the plan view of the road such that the road areas contain the route nodes and match the shape of the road through which the first route passes in the plan view, and the altitude of the road areas is set based on the altitude of the route nodes. Accordingly, it is possible to acquire the second route such that the shape of the road and altitude of the second route match those of the first route.

In the above aspect, preferably, the second map includes a delimiting line indicating a side edge on one lateral side of the lane, the delimiting line is expressed as delimiting line nodes (A) defined by the latitude, longitude, and altitude, and in the step of extracting the lane nodes, extracting a boundary (H) of a roadway corresponding to the first route from the image data and setting each of the road areas defined by a prescribed latitudinal range, longitudinal range, and altitudinal range, extracting the delimiting line nodes arranged inside the road areas, and extracting the lane nodes that match the route nodes by using the extracted delimiting line nodes.

According to this aspect, it is possible to set the road areas so as to match the shape of the road the first route passes through in the plan view. Further, by extracting the delimiting line nodes by using the road areas, it is possible to extract the lane nodes that match the route nodes with respect to the altitude.

In the above aspect, preferably, in the step of extracting the lane nodes, extracting the lane nodes arranged between the extracted delimiting line nodes and the delimiting line nodes indicating another side edge of the lane opposite to the extracted delimiting line nodes, thereby extracting the lane nodes that match the route nodes.

According to this aspect, it is possible to extract the lane nodes by using the road areas.

To achieve such an object, one aspect of the present invention provides a non-transitory computer-readable storage medium, comprising a route data conversion program for acquiring a second route on a second map that matches a first route on a first map, the first route being expressed as route nodes (N) and route links (M), the route nodes being defined by latitude, longitude, and altitude, the route links (M) connecting the route nodes, the second map including a lane expressed as lane nodes (C) and lane links (D), the lane nodes being defined by the latitude, longitude, and altitude, the lane links connecting the lane nodes, wherein the route data conversion program, when executed by a processor (32), executes a route data conversion method comprising: extracting the lane nodes whose latitude, longitude, and altitude match the latitude, longitude, and altitude of the route nodes respectively (step ST1 and step ST15); and acquiring the second route by connecting the extracted lane nodes (step ST3 and step ST16).

According to this aspect, the lane nodes that match the route nodes with respect to the altitude are extracted, and thus the second route is acquired. Accordingly, even if the first route passes through multi-level crossing roads, it is possible to substantially determine which one of the multi-level crossing roads the first route passes through based on the altitude, so that an appropriate second route can be acquired.

In the above aspect, preferably, in the step of extracting the lane nodes, extracting areas (Pc) containing the route nodes from an intermediate map including the areas (P) centered on the lane nodes and area links (Q) connecting the areas, thereby extracting the lane nodes whose latitude, longitude, and altitude match the latitude, longitude, and altitude of the route nodes respectively.

According to this aspect, even if the route nodes on the first map do not completely match the lane nodes on the second map, it is possible to extract the lane nodes that match the route nodes.

In the above aspect, preferably, the first map includes image data (G) showing a plan view of a road, and in the step of extracting the lane nodes, acquiring road areas (J) based on the image data and the route nodes such that the road areas contain the route nodes and match not only a shape of the road through which the first route passes but also the altitude of the route nodes in the plan view, and extracting the lane nodes that match the road areas.

According to this aspect, the road areas are set based on the image data showing the plan view of the road such that the road areas contain the route nodes and match the shape of the road through which the first route passes in the plan view, and the altitude of the road areas is set based on the altitude of the route nodes. Accordingly, it is possible to acquire the second route such that the shape of the road and altitude of the second route match those of the first route.

To achieve such an object, one aspect of the present invention provides a route data conversion device (16) for acquiring a second route on a second map that matches a first route on a first map, the first route being expressed as route nodes (N) and route links (M), the route nodes being defined by latitude, longitude, and altitude, the route links (M) connecting the route nodes, the second map including a lane expressed as lane nodes (C) and lane links (D), the lane nodes being defined by the latitude, longitude, and altitude, the lane links connecting the lane nodes, wherein the route data conversion device comprising a processor (32) configured to: extract the lane nodes whose latitude, longitude, and altitude match the latitude, longitude, and altitude of the route nodes respectively (step ST1 and step ST15); and acquire the second route by connecting the extracted lane nodes (step ST3 and step ST16).

According to this aspect, the lane nodes that match the route nodes with respect to the altitude are extracted, and thus the second route is acquired. Accordingly, even if the first route passes through multi-level crossing roads, it is possible to substantially determine which one of the multi-level crossing roads the first route passes through based on the altitude, so that an appropriate second route can be acquired.

In the above aspect, preferably, in the step of extracting the lane nodes, extracting areas (Pc) containing the route nodes from an intermediate map including the areas (P) centered on the lane nodes and area links (Q) connecting the areas, thereby extracting the lane nodes whose latitude, longitude, and altitude match the latitude, longitude, and altitude of the route nodes respectively.

According to this aspect, even if the route nodes on the first map do not completely match the lane nodes on the second map, it is possible to extract the lane nodes that match the route nodes.

In the above aspect, preferably, the first map includes image data (G) showing a plan view of a road, and in the step of extracting the lane nodes, acquiring road areas (J) based on the image data and the route nodes such that the road areas contain the route nodes and match not only a shape of the road through which the first route passes but also the altitude of the route nodes in the plan view, and extracting the lane nodes that match the road areas.

According to this aspect, the road areas are set based on the image data showing the plan view of the road such that the road areas contain the route nodes and match the shape of the road through which the first route passes in the plan view, and the altitude of the road areas is set based on the altitude of the route nodes. Accordingly, it is possible to acquire the second route such that the shape of the road and altitude of the second route match those of the first route.

Thus, according to the above aspects, it is possible to provide a route data conversion method, a non-transitory computer-readable storage medium, and a route data conversion device for acquiring a second route on a second map that matches a first route on a first map, more specifically, for acquiring an appropriate second route even if a first route is passing through multi-level crossing roads.

### BRIEF DESCRIPTION OF THE DRAWING(S)

FIG. 1 is a functional block diagram showing the configuration of a map information system for executing a route data conversion method according to a first embodiment;

FIG. 2A is an explanatory diagram for explaining a navigation map;

FIG. 2B is an explanatory diagram for explaining a high-precision map;

FIG. 3 is an explanatory diagram for explaining intermediate data;

FIG. 4 is a sequence diagram for explaining an operation executed by the map information system in a case where a vehicle travels autonomously;

FIG. 5 is a flowchart of a route data conversion process (linking process) according to the first embodiment;

FIG. 6A is an explanatory diagram for explaining navigation map nodes and navigation map links in a case where a route set by a navigation device passes through multi-level crossing roads;

FIG. 6B is an explanatory diagram for explaining cuboid areas and area links in a case where the route set by the navigation device passes through the multi-level crossing roads;

FIG. 7A is an explanatory diagram showing reference cuboid areas extracted from the cuboid areas shown in FIG. 6B;

FIG. 7B is an explanatory diagram showing a route on the high-precision map corresponding to the route on the navigation map;

FIG. 8 is a flowchart of a route data conversion process (linking process) according to a second embodiment;

FIG. 9A is an explanatory diagram for explaining rectangles from which road areas are acquired;

FIG. 9B is an explanatory diagram for explaining delimiting line nodes extracted from the road areas; and

FIG. 9C is an explanatory diagram showing a route on a high-precision map acquired based on the extracted delimiting line nodes.

### DETAILED DESCRIPTION OF THE INVENTION

In the following, a route data conversion method, a non-transitory computer-readable storage medium including a route data conversion program, and a route data conversion device according to an embodiment of the present invention will be described with reference to the drawings. The route data conversion method is a method for linking map data used for setting a route from a current position to a destination with more detailed map data held by a vehicle that travels autonomously. The route data conversion method can be rephrased as “the linking method of the map data”.

### The First Embodiment

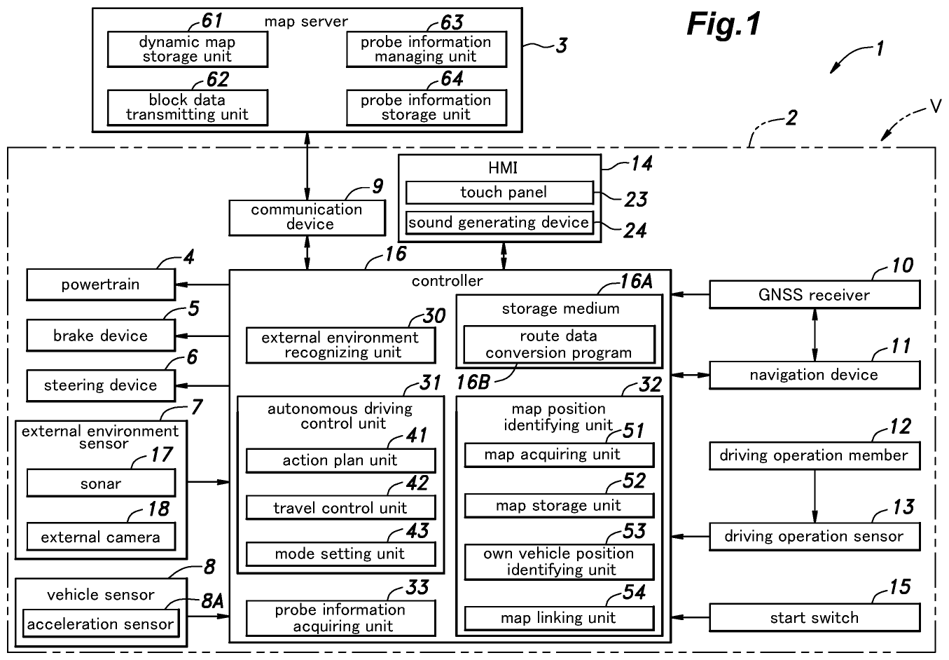

The route data conversion method is used in a map information system 1. As shown in FIG. 1, the map information system 1 includes a vehicle system 2 mounted on a vehicle (see “V” in FIG. 1), and a map server 3 connected to the vehicle system 2 via a network. Hereinafter, the configuration and operation of the vehicle system 2 and the map server 3 will be described, and then the linking method of the map data will be described.

### <The Vehicle System>

First, the vehicle system 2 will be described. The vehicle system 2 includes a powertrain 4, a brake device 5, a steering device 6, an external environment sensor 7, a vehicle sensor 8, a communication device 9, a GNSS receiver 10, a navigation device 11, a driving operation member 12, a driving operation sensor 13, an HMI 14, a start switch 15, and a controller 16. Each component of the vehicle system 2 is connected to each other via a communication means such as Controller Area Network (CAN) such that signals can be transmitted therebetween.

The powertrain 4 is a device configured to apply a driving force to the vehicle. For example, the powertrain 4 includes at least one of an internal combustion engine (such as a gasoline engine and a diesel engine) and an electric motor. The brake device 5 is a device configured to apply a brake force to the vehicle. For example, the brake device 5 includes a brake caliper configured to press a pad against a brake rotor and an electric cylinder configured to supply an oil pressure to the brake caliper. The brake device 5 may further include a parking brake device configured to restrict rotation of wheels via wire cables. The steering device 6 is a device configured to change the steering angles of the wheels. For example, the steering device 6 includes a rack-and-pinion mechanism configured to steer the wheels and an electric motor configured to drive the rack-and-pinion mechanism. The powertrain 4, the brake device 5, and the steering device 6 are controlled by the controller 16.

The external environment sensor 7 is a sensor configured to detect an object outside the vehicle or the like by capturing electromagnetic waves, sound waves, or the like from the surroundings of the vehicle. The external environment sensor 7 includes a plurality of sonars 17 and a plurality of external cameras 18. The external environment sensor 7 may further include a millimeter wave radar and/or a laser lidar. The external environment sensor 7 is configured to output a detection result to the controller 16.

Each sonar 17 consists of a so-called ultrasonic sensor. The sonar 17 emits ultrasonic waves to the surroundings of the vehicle and captures the reflected waves therefrom, thereby detecting a position (distance and direction) of the object. The plurality of sonars 17 are provided at a rear part and a front part of the vehicle, respectively.

Each external camera 18 is a device configured to capture an image of the surroundings of the vehicle. For example, the external camera 18 is a digital camera that uses a solid imaging element such as a CCD and a CMOS. The external camera 18 may consist of a stereo camera or a monocular camera. The plurality of external cameras 18 include a front camera configured to capture an image in front of the vehicle, a rear camera configured to capture an image behind the vehicle, and a pair of side cameras configured to capture images on both lateral sides of the vehicle.

The vehicle sensor 8 is a sensor configured to detect the state of the vehicle. The vehicle sensor 8 includes a vehicle speed sensor configured to detect the speed of the vehicle, an acceleration sensor 8A configured to detect the front-and-rear acceleration and the lateral acceleration of the vehicle, a yaw rate sensor configured to detect the angular velocity around a yaw axis of the vehicle, a direction sensor configured to detect the direction of the vehicle, and the like. For example, the yaw rate sensor may consist of a gyro sensor. The vehicle sensor 8 may further include an inclination sensor configured to detect the inclination of a vehicle body and a wheel speed sensor configured to detect the rotational speed of each wheel.

In the present embodiment, the vehicle sensor 8 includes a 6-axis inertial measurement unit (IMU) configured to detect the front-and-rear acceleration, the lateral acceleration, the vertical acceleration, the roll rate (the angular velocity around a roll axis), the pitch rate (the angular velocity around a pitch axis), and the yaw rate (the angular velocity around a yaw axis).

The communication device 9 is configured to mediate communication between the controller 16 and a device (for example, the map server 3) outside the vehicle. The communication device 9 includes a router configured to connect the controller 16 to the Internet. The communication device 9 may have a wireless communication function of mediating wireless communication between the controller 16 (namely, the controller 16 of the own vehicle) and the controller of the surrounding vehicle and between the controller 16 and a roadside device on a road.

The GNSS receiver 10 (the own vehicle position identifying device) is configured to receive a signal (hereinafter referred to as “the GNSS signal”) from each of positioning satellites that constitute a Global Navigation Satellite System (GNSS). The GNSS receiver 10 is configured to output the received GNSS signal to the navigation device 11 and the controller 16.

The navigation device 11 consists of a computer provided with known hardware. The navigation device 11 is configured to identify the current position (latitude and longitude) of the vehicle based on the previous travel history of the vehicle and the GNSS signal outputted from the GNSS receiver 10.

The navigation device 11 is configured to store map data (hereinafter referred to as “the navigation map”) in a RAM, an HDD, an SSD, or the like. The navigation map includes a database (hereinafter referred to as “the navigation map DB”) of road information on a region or a country in which the vehicle is traveling and image data G for displaying a route R on the HMI 14.

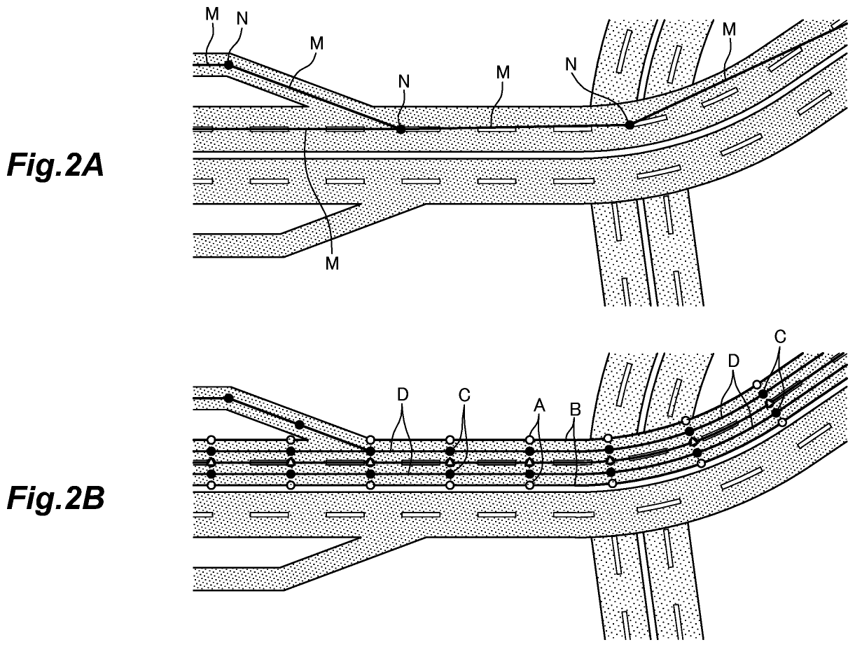

As shown in FIG. 2A, the navigation map DB stores, as information on the roads on the map, information on points (navigation map nodes N: see black circles in FIG. 2A) arranged on each road and line segments (navigation map links M: see solid lines in FIG. 2A) each connecting two of the navigation map nodes N. The navigation map nodes N are provided at points where multi-level crossing roads are present (that is, points where roads cross on multiple levels so as to compose a grade separation). Further, the navigation map nodes N are appropriately provided at characteristic points such as intersections, merging points, and curves.

The navigation map DB includes a navigation map node table in which information on the navigation map nodes N is stored and a navigation map link table in which information on navigation map links M is stored.

The navigation map node table stores IDs (hereinafter referred to as “the node IDs”) indicating the respective navigation map nodes N and latitude, longitude, and altitude (more specifically, altitude above an average sea level of Tokyo Bay as a reference plane) indicating positions of the navigation map nodes N.

The navigation map link table stores IDs (hereinafter referred to as “the link IDs”) indicating the respective navigation map links M, information (for example, the node IDs) on the two navigation map nodes N connected by the corresponding navigation map link M, and a distance between the connected two navigation map nodes N such that these pieces of information are associated with each other. The navigation map nodes N and the navigation map links M constitute a road network showing the connections of the roads on the map.

The image data G is data of images showing a plan view of roads, forests, buildings, or the like. Further, in the present embodiment, the image data G includes information on characters or the like. The image data G may be configured by superimposition of a plurality of layers such as a layer showing the plan view of roads and forests, a layer showing the plan view of buildings, and a layer showing the information on characters.

The navigation device 11 is configured to acquire an appropriate route R (for example, a route with the shortest distance: first route) from the current position of the vehicle to the destination based on the distance between the navigation map nodes N stored in the navigation map link table of the navigation map DB. The navigation device 11 is configured to output information indicating the route R to the controller 16. The route R output to the controller 16 is expressed as a plurality of navigation map nodes N (route nodes) and a plurality of navigation map links M (route links). The navigation map nodes N are defined by latitude, longitude, and altitude. The navigation map links M connect the navigation map nodes N.

The navigation device 11 is configured to set, based on the GNSS signal and the data stored in the navigation map DB, the route R from the current position of the vehicle to the destination input by the occupant, and outputs the route R to the controller 16.

When the vehicle starts traveling, the navigation device 11 displays the set route R on the HMI 14 such that the set route R is superimposed on the corresponding image data G, thereby providing route guidance.

The driving operation member 12 is provided in a vehicle cabin and configured to accept an input operation the occupant performs to control the vehicle. The driving operation member 12 includes a turn signal lever, a steering wheel, an accelerator pedal, and a brake pedal. The driving operation member 12 may further include a shift lever, a parking brake lever, and the like.

The driving operation sensor 13 is a sensor configured to detect an operation amount of the driving operation member 12. The driving operation sensor 13 includes a turn signal lever sensor configured to detect an input operation on the turn signal lever by the occupant, a steering angle sensor configured to detect an operation amount of the steering wheel, an accelerator sensor configured to detect an operation amount of the accelerator pedal, and a brake sensor configured to detect an operation amount of the brake pedal. The driving operation sensor 13 is configured to output the detected operation amount to the controller 16. The turn signal lever sensor is configured to detect the operation input (input operation) to the turn signal lever and an indicating direction corresponding to the operation input. The driving operation sensor 13 may further include a grip sensor configured to detect that the occupant grips the steering wheel. For example, the grip sensor consists of at least one capacitive sensor provided on an outer circumferential portion of the steering wheel.

The HMI 14 is configured to notify the occupant of various kinds of information by display and/or voice, and accept an input operation by the occupant. For example, the HMI 14 includes a touch panel 23 and a sound generating device 24. The touch panel 23 includes a liquid crystal display, an organic EL display, or the like, and is configured to accept the input operation by the occupant. The sound generating device 24 consists of a buzzer and/or a speaker. The HMI 14 is configured to display a driving mode switch button on the touch panel 23. The driving mode switch button is a button configured to accept a switching operation of a driving mode (for example, an autonomous driving mode and a manual driving mode) of the vehicle by the occupant.

The HMI 14 also functions as an interface to mediate the input to/the output from the navigation device 11. Namely, when the HMI 14 accepts the input operation of the destination by the occupant, the navigation device 11 starts setting the route R to the destination. Further, when the navigation device 11 provides the route guidance to the destination, the HMI 14 displays the current position of the vehicle and the route R to the destination.

The start switch 15 is a switch for starting the vehicle system 2. Namely, the occupant presses the start switch 15 while sitting on the driver's seat and pressing the brake pedal, and thus the vehicle system 2 is started.

The controller 16 consists of at least one electronic control unit (ECU) including a CPU, a ROM, a RAM, and the like. The CPU executes operation processing according to a program, and thus the controller 16 executes various types of vehicle control. The controller 16 may consist of one piece of hardware, or may consist of a unit including plural pieces of hardware. The functions of the controller 16 may be at least partially executed by hardware such as an LSI, an ASIC, and an FPGA, or may be executed by a combination of software and hardware.

### <The Controller>

As shown in FIG. 1, the controller 16 includes an external environment recognizing unit 30, an autonomous driving control unit 31 (ADAS: Advanced Driver-Assistance Systems), a map position identifying unit 32 (MPU: Map Positioning Unit), and a probe information acquiring unit 33. These components may be composed of separate electronic control units and connected to each other via a gateway (central gateway: CGW). Alternatively, these components may be composed of an integrated electronic control unit.

The external environment recognizing unit 30 is configured to recognize an object that is present in the surroundings of the vehicle based on the detection result of the external environment sensor 7, and thus acquire information on the position and size of the object. The object recognized by the external environment recognizing unit 30 includes delimiting lines, lanes, road ends, road shoulders, and obstacles, which are present on the travel route of the vehicle.

Each delimiting line is a line shown along a vehicle travel direction. Each lane is an area delimited by one or more delimiting lines. Each road end is an end of the road. Each road shoulder is an area between the delimiting line arranged at an end in the vehicle width direction and the road end. For example, each obstacle may be a barrier (guardrail), a utility pole, a surrounding vehicle, a pedestrian, or the like.

The external environment recognizing unit 30 is configured to recognize the position of the object around the vehicle with respect to the vehicle by analyzing the image captured by each external camera 18. For example, the external environment recognizing unit 30 may recognize the distance and direction from the vehicle to the object in a top view around the vehicle body by using a known method such as a triangulation method or a motion stereo method. Further, the external environment recognizing unit 30 is configured to analyze the image captured by the external camera 18, and determine the type (for example, the delimiting line, the lane, the road end, the road shoulder, the obstacle, or the like) of each object based on a known method.

The autonomous driving control unit 31 includes an action plan unit 41, a travel control unit 42, and a mode setting unit 43.

The action plan unit 41 is configured to create an action plan for causing the vehicle to travel. The action plan unit 41 is configured to output a travel control signal corresponding to the created action plan to the travel control unit 42.

The travel control unit 42 is configured to control the powertrain 4, the brake device 5, and the steering device 6 based on the travel control signal from the action plan unit 41. Namely, the travel control unit 42 is configured to cause the vehicle to travel according to the action plan created by the action plan unit 41.

The mode setting unit 43 is configured to switch the driving mode of the vehicle between the manual driving mode and the autonomous driving mode based on the input operation (switching operation) on the HMI 14. In the manual driving mode, the travel control unit 42 controls the powertrain 4, the brake device 5, and the steering device 6 in response to the input operation on the driving operation member 12 (for example, the steering wheel, the accelerator pedal and/or the brake pedal) by the occupant, thereby causing the vehicle to travel. On the other hand, in the autonomous driving mode, the occupant does not need to perform the input operation on the driving operation member 12, and the travel control unit 42 controls the powertrain 4, the brake device 5, and the steering device 6, thereby causing the vehicle to travel autonomously. Namely, a driving automation level of the autonomous driving mode is higher than that of the manual driving mode.

The map position identifying unit 32 includes a map acquiring unit 51, a map storage unit 52, an own vehicle position identifying unit 53, and a map linking unit 54.

The map acquiring unit 51 is configured to access the map server 3 and acquire dynamic map data, which is high-precision map information, from the map server 3. For example, as the navigation device 11 sets the route R, the map acquiring unit 51 acquires the latest dynamic map data of an area corresponding to the route R from the map server 3 via the communication device 9.

The dynamic map data is more detailed than the navigation map stored in the navigation device 11, and includes static information, semi-static information, semi-dynamic information, and dynamic information. The static information includes 3D map data that is more precise than the navigation map. The semi-static information includes traffic regulation information, road construction information, and wide area weather information. The semi-dynamic information includes accident information, traffic congestion information, and small area weather information. The dynamic information includes signal information, surrounding vehicle information, and pedestrian information.

As shown in FIG. 2B, the static information (high-precision map data: hereinafter referred to as “the high-precision map”) of the dynamic map data includes information (hereafter referred to as “the delimiting line data”) on the delimiting lines on each road. On the high-precision map, each delimiting line is expressed as nodes (white circles in FIG. 2B: hereinafter referred to as “the delimiting line nodes A”) arranged at shorter intervals than the navigation map nodes N and delimiting line links B connecting the delimiting line nodes A. The delimiting line data includes information on positions (latitude, longitude, and altitude) of the delimiting line nodes A, information on the delimiting line nodes A connected by the delimiting line links B, or the like. Incidentally, FIG. 2B shows an example in which two roads each having two lanes on one lateral side cross on multiple levels, and the after-mentioned lane nodes C, the delimiting line nodes A, and the like of the lower road are omitted.

The high-precision map includes information (hereinafter referred to as “the lane data”) on the lanes on each road. In the high-precision map, the lanes are expressed as nodes (hereinafter referred to as “the lane nodes C”: see black circles in FIG. 2B) arranged at prescribed intervals and links (hereinafter referred to as “the lane links D”) connecting the lane nodes C. Each lane node C indicates a position, and is defined by latitude, longitude, and altitude. Each lane link D connects two adjacent lane nodes C. The intervals at which the lane nodes C are arranged may be substantially the same as the intervals at which the delimiting line nodes A are arranged. The lane nodes C are arranged between the delimiting line nodes A defining a left side edge of the lane and the delimiting line nodes A defining a right side edge thereof (more specifically, arranged substantially in the center of these delimiting line nodes A). That is, each delimiting line indicates one lateral side edge of the lane expressed as the lane nodes C and the lane links D. The lane data includes information on the positions (latitude, longitude, and altitude) of the lane nodes C, information on the lane nodes C connected by the lane links D, and the like.

Furthermore, the high-precision map may include information on roadways on each road. Each roadway is expressed as nodes (see triangles in FIG. 2B) arranged at prescribed intervals and links connecting the nodes. The nodes indicating the roadway may be arranged between the delimiting line nodes A provided at both lateral ends of the road.

The high-precision map includes a database (hereinafter referred to as “the high-precision map DB”) in which information on the delimiting lines, the lanes, and the like are stored. The high-precision map DB includes, for example, a lane node table in which information on the lane nodes C is stored. The lane node table stores IDs (hereinafter referred to as “the lane node IDs”) of the lane nodes C and the positions of the corresponding lane nodes C, that is, latitude, longitude, and altitude of the corresponding lane nodes C. The high-precision map DB includes a lane link table that stores information on the lane links D. The lane link table stores IDs (hereinafter referred to as “the lane link IDs”) of the lane links D and information (for example, two lane node IDs) on two lane nodes C connected by the corresponding lane link D such that the lane link IDs and the information thereon are associated with each other.

When acquiring dynamic map data including the high-precision map, the map acquiring unit 51 simultaneously acquires corresponding intermediate data (intermediate map) from the map server 3.

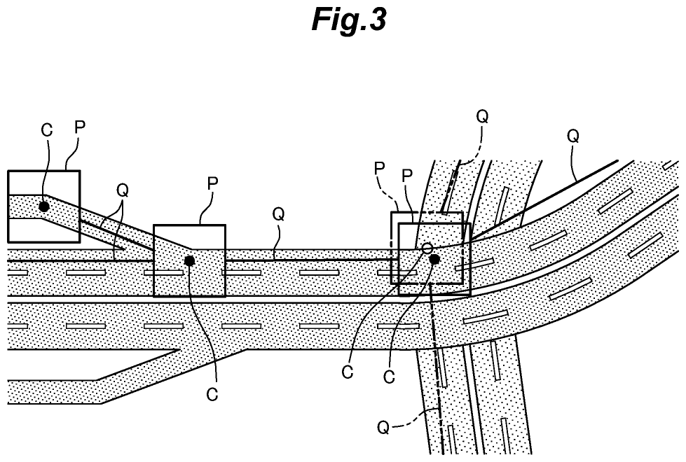

As shown in FIG. 3, the intermediate data stores information on a plurality of cuboid areas P and a plurality of area links Q each connecting two of the cuboid areas P.

Each cuboid area P indicates an area where each navigation map node N is estimated to be set. More specifically, the cuboid area P indicates a cuboid-like area centered on the lane node C arranged at the characteristic point (that is, the point where the navigation map node N can be set) such as an intersection and a multi-level crossing point. The cuboid area P is defined as an area within a prescribed latitudinal range centered on the lane node C, within a prescribed longitudinal range centered on the lane node C, and within a prescribed altitudinal range centered on the lane node C. In the present embodiment, the latitudinal range and the longitudinal range are set to the same length, and thus the cuboid area P has a rectangular shape (a square shape) in the top view. The altitudinal range is set to be smaller than an altitudinal difference between two roads crossing on multiple levels. Incidentally, FIG. 3 shows an example in which two roads each having two lanes on one lateral side cross on multiple levels, and the cuboid areas P and the area links Q of two lanes on one lateral side of each road are omitted. Further, in FIG. 3, the lane node C corresponding to the lower road is shown by a white circle, and the cuboid area P and the area links Q corresponding thereto are shown by two-dot chain lines.

Each area link Q connects adjacent cuboid areas P arranged in the same lane.

The intermediate data includes a database (hereinafter referred to as “the intermediate data DB”) storing an area table in which information on the cuboid areas P is stored and an area link table in which information on the area links Q is stored. The area table stores an ID, a latitudinal range (the lower limit and upper limit of latitude), a longitudinal range (the lower limit and upper limit of longitude), and an altitudinal range (the lower limit and upper limit of altitude) of each cuboid area P. The area link table stores IDs of the area links Q and IDs indicating two cuboid areas P connected by the corresponding area link Q.

The map storage unit 52 includes a storage unit such as an HDD and an SSD. The map storage unit 52 is configured to store various kinds of information for causing the vehicle to travel autonomously in the autonomous driving mode. The map storage unit 52 is configured to store the dynamic map data and the intermediate data acquired by the map acquiring unit 51 from the map server 3.

The own vehicle position identifying unit 53 is configured to identify the position (latitude and longitude) of the vehicle, namely the own vehicle position based on the GNSS signal received by the GNSS receiver 10.

The own vehicle position identifying unit 53 is configured to calculate a movement amount (a movement distance and a movement direction: hereinafter referred to as “the DR movement amount”) of the vehicle by using dead reckoning (for example, odometry) based on a detection result of the vehicle sensor 8 (IMU or the like). For example, the own vehicle position identifying unit 53 is configured to identify the own vehicle position based on the DR movement amount when the GNSS signal cannot be received. Further, the own vehicle position identifying unit 53 may execute a process for improving the identification accuracy of the own vehicle position by correcting, based on the DR movement amount, the own vehicle position identified from the GNSS signal.

The map linking unit 54 is configured to extract, based on the route R output from the navigation device 11, a corresponding route S on the high-precision map stored in the map storage unit 52.

When the vehicle is given an instruction to start traveling autonomously, the action plan unit 41 creates a global action plan (for example, a lane change, merging, branching, or the like) based on the route S extracted by the map linking unit 54. After that, when the vehicle starts traveling autonomously, the action plan unit 41 creates a more detailed action plan (for example, an action plan for avoiding danger or the like) based on the global action plan, the own vehicle position identified by the own vehicle position identifying unit 53, the object recognized by the external environment recognizing unit 30, the high-precision map stored in the map storage unit 52, or the like. The travel control unit 42 controls the travel of the vehicle based on the created detailed action plan.

The probe information acquiring unit 33 associates the own vehicle position, which is identified by the own vehicle position identifying unit 53 based on the GNSS signal, with the data detected by at least one of the external environment sensor 7, the vehicle sensor 8, and the driving operation sensor 13, thereby acquiring and storing the own vehicle position and the data as probe information.

The probe information acquiring unit 33 appropriately transmits the acquired probe information to the map server 3.

### <The Map Server>

Next, the map server 3 will be described. As shown in FIG. 1, the map server 3 is connected to the controller 16 via the network (in the present embodiment, the Internet). The map server 3 is a computer including a CPU, a ROM, a RAM, and a storage unit such as an HDD and an SSD.

The dynamic map data is stored in the storage unit of the map server 3. The dynamic map data stored in the storage unit of the map server 3 covers a wider area than the dynamic map data stored in the map storage unit 52 of the controller 16. The dynamic map data includes a plurality of block data (partial map data) corresponding to each area on the map. Preferably, each of the block data corresponds to a rectangular area on the map divided in the latitude direction and the longitude direction.

Not only the dynamic map data but also the corresponding intermediate data is stored in the storage unit of the map server 3. The intermediate data stored in the storage unit of the map server 3 may be the dynamic map data covering a wider area than the intermediate data stored in the map storage unit 52 of the controller 16, and may be divided into a plurality of blocks so as to correspond to each area on the map.

Upon receiving a request for data from the controller 16 (the map acquiring unit 51) via the communication device 9, the map server 3 transmits the dynamic map and the intermediate data corresponding to the requested data to the corresponding controller 16. The transmitted data (the dynamic map data) may include the traffic congestion information, the weather information, and the like.

As shown in FIG. 1, the map server 3 includes a dynamic map storage unit 61, a block data transmitting unit 62, a probe information managing unit 63, and a probe information storage unit 64.

The dynamic map storage unit 61 consists of a storage unit, and is configured to store a dynamic map in an area wider than an area in which the vehicle travels. The block data transmitting unit 62 is configured to accept a transmission request for specific block data from the vehicle, and transmit the block data and the corresponding intermediate data corresponding to the transmission request to the vehicle.

The probe information managing unit 63 is configured to receive the probe information appropriately transmitted from the vehicle. The probe information storage unit 64 is configured to store (hold) the probe information acquired (received) by the probe information managing unit 63. The probe information managing unit 63 appropriately executes statistical processing and the like based on the probe information stored in the probe information storage unit 64, thereby executing an updating process for updating the dynamic map.

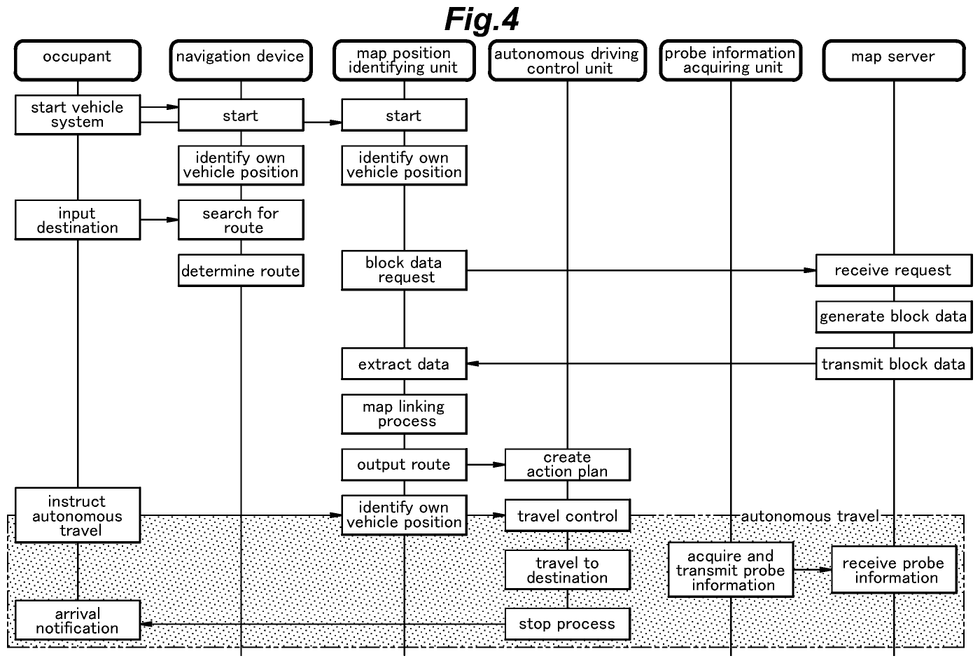

Next, the operation of the vehicle system 2 will be described. The vehicle system 2 is started as the occupant boards the vehicle and presses the start switch 15 while pressing the brake pedal. After that, as the occupant inputs the destination and makes an input to start autonomous travel to the HMI 14, the vehicle travels autonomously and arrives at the destination. FIG. 4 shows a sequence diagram from the start of the vehicle to the arrival at the destination. Hereinafter, the outline of the processing (operation) executed by the autonomous driving control unit 31, the map position identifying unit 32, the probe information acquiring unit 33, and the map server 3 when the vehicle travels autonomously and arrives at the destination will be described with reference to FIG. 4.

When the start switch 15 is pressed and the vehicle system 2 starts, the navigation device 11 and the map position identifying unit 32 each identify the own vehicle position based on the GNSS signal from the satellites.

After that, when the occupant inputs the destination to the HMI 14, the navigation device 11 searches for and determines the route R from the current position to the destination based on the navigation map, and outputs the determined route R to the map position identifying unit 32. The map position identifying unit 32 requests the map server 3 to transmit the corresponding block data based on the acquired route R.

Upon receiving the request (block data request) from the map position identifying unit 32, the map server 3 generates the corresponding block data based on the route R set (determined) by the navigation device 11 and the position of the vehicle, and transmits the generated block data to the map position identifying unit 32 (the vehicle system 2).

Upon receiving the block data, the map position identifying unit 32 acquires (extracts), from the block data, the data relating to the dynamic map and the intermediate data each corresponding to the route R set by the navigation device 11.

After that, the map position identifying unit 32 executes a map linking process (linking process) for acquiring the route S (second route) on the high-precision map (second map) corresponding to the route R based on the route R (first route) from the starting point to the destination on the navigation map (first map) set by the navigation device 11. The map position identifying unit 32 outputs the acquired route S on the high-precision map to the autonomous driving control unit 31.

Next, the autonomous driving control unit 31 (the action plan unit 41) creates the global action plan according to the route S on the high-precision map.

When an input to instruct the vehicle to travel autonomously is made on the HMI 14, the map position identifying unit 32 identifies the own vehicle position, and the autonomous driving control unit 31 sequentially creates the more detailed action plan based on the identified own vehicle position, the position of the object recognized by the external environment recognizing unit 30, and the like. The autonomous driving control unit 31 (the travel control unit 42) controls the vehicle according to the created action plan, thereby causing the vehicle to travel autonomously.

When the vehicle starts traveling, the probe information acquiring unit 33 starts acquiring the probe information. While the vehicle is traveling, the probe information acquiring unit 33 appropriately transmits the acquired probe information to the map server 3 as the probe information during autonomous driving. Upon receiving the probe information during autonomous driving, the map server 3 stores (holds) the received probe information, and appropriately updates the dynamic map based on the probe information.

When the vehicle arrives at the destination, the autonomous driving control unit 31 executes a stop process for stopping the vehicle, and the HMI 14 displays a notification that the vehicle arrives at the destination.

In this way, by executing the linking process, the map position identifying unit 32 acquires the route R (first route) on the navigation map (first map) stored in the navigation device 11 and the route S (second route) on the high-precision map (second map). That is, the linking process is a process for acquiring the route R on the navigation map and the route S on the high-precision map that matches the route R. The map position identifying unit 32 is configured to acquire the route R on the navigation map and the route S on the high-precision map that matches the route R by executing a linking program (route data conversion program) for executing the linking process. Accordingly, the controller 16 including the map position identifying unit 32 (processor) functions as a route data conversion device for acquiring the route R (first route) on the navigation map (first map) stored in the navigation device 11 and the route S (second route) on the high-precision map (second map) that matches the route R. As shown in FIG. 1, the controller 16 includes a non-transitory computer-readable storage medium 16A including a route data conversion program 16B, and the data compression program 16B, when executed by the map position identifying unit 32 (processor), executes the after-mentioned route data conversion method.

### <The Linking Method of the Map Data (the Route Data Conversion Method)>

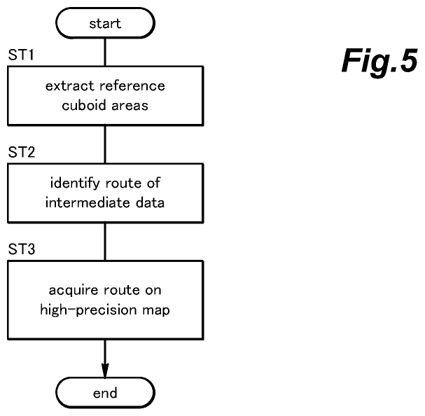

Next, the details of the linking process (a route data conversion process) executed by the map position identifying unit 32 will be described with reference to a flowchart shown in FIG. 5.

In the first step ST1 of the linking process, the map linking unit 54 of the map position identifying unit 32 acquires the positions (latitude, longitude, and altitude) of all the navigation map nodes N included in the route R determined by the navigation device 11. After that, the map linking unit 54 extracts the cuboid areas P one by one from the intermediate data stored in the map storage unit 52, determines whether the navigation map nodes N are contained in the extracted cuboid areas P, and extracts the cuboid areas P containing the navigation map nodes N as reference cuboid areas Pc. The map linking unit 54 determines whether the navigation map nodes N are contained in the cuboid areas P (that is, whether the navigation map nodes N are arranged inside the cuboid areas P) with respect to not only latitude and longitude but also altitude. Upon completing the extraction of the reference cuboid areas Pc with respect to all the navigation map nodes N included in the route R, the map linking unit 54 executes step ST2.

In step ST2, the map linking unit 54 refers to the intermediate data, thereby extracting the area links Q that connect the reference cuboid areas Pc. After that, the map linking unit 54 identifies the route of the intermediate data by tracing the extracted area links Q. Upon completing the identification of the route of the intermediate data, the map linking unit 54 executes step ST3.

In step ST3, the map linking unit 54 first acquires, with respect to each area link Q included in the route of the intermediate data, two reference cuboid areas Pc connected by the area link Q. After that, the map linking unit 54 extracts two lane nodes C arranged at the centers of the acquired two reference cuboid areas Pc. After that, the map linking unit 54 connects the extracted two lane nodes C by tracing the lane link D. The map linking unit 54 executes such a process for all the area links Q included in the route of the intermediate data, thereby acquiring the route S on the high-precision map. Upon completing acquisition of the route S on the high-precision map, the map linking unit 54 ends the linking process.

Next, the effect of the linking process executed by the map position identifying unit 32 (map linking unit 54) will be described. The map linking unit 54 substantially extracts the lane nodes C whose latitude, longitude, and altitude match the latitude, longitude, and altitude of the navigation map nodes N respectively by extracting the cuboid areas P containing the navigation map nodes N (step ST1: an extracting step). After that, the map linking unit 54 acquires the route S on the high-precision map by tracing (connecting) the extracted lane nodes C (step ST3: a connecting step).

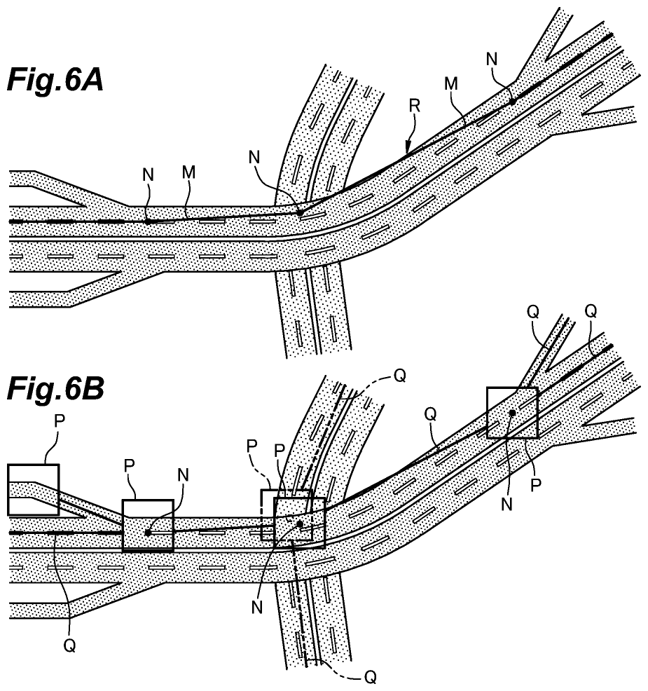

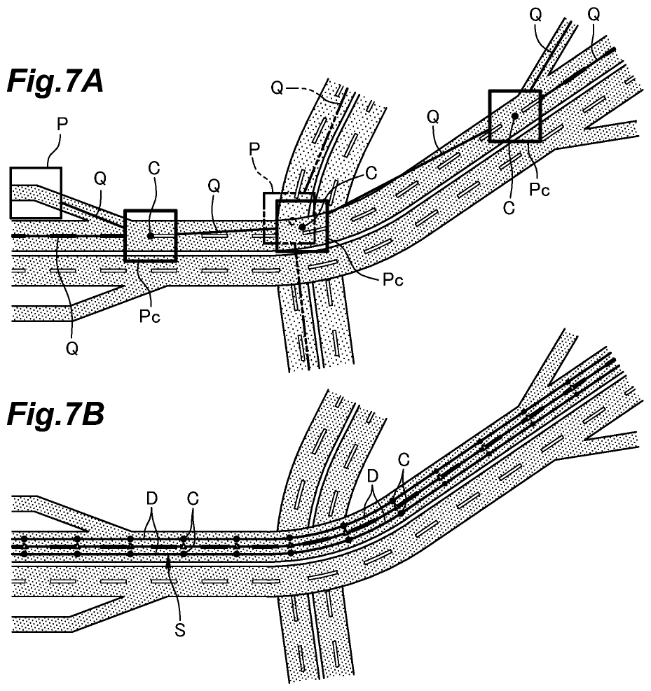

In the following, the effect of such a process will be described. As shown in FIGS. 6A, 6B, 7A and 7B, the description will be given of a case where the route R determined by the navigation device 11 passes through a point where two multi-level crossing roads (that is, two roads crossing on multiple levels) are present. Especially, the description will be given of a case where the route R determined by the navigation device 11 passes through the upper road. However, the same effect can be exhibited in a case where the route R passes through the lower road and a case where three or more multi-level crossing roads are present, and the description of these extra cases will be omitted. FIGS. 6B and 7A show an example in which two roads having two lanes on one lateral side cross on multiple levels, and the cuboid areas P and the area links Q of two lanes on one lateral side of each road are omitted.

As shown in FIG. 6A, in a case where the route R determined by the navigation device 11 passes through two roads crossing on multiple levels, the navigation map node N is arranged at a point where the two roads cross on multiple levels. On the other hand, as shown in FIG. 6B, the cuboid areas P corresponding to the lane nodes C of two roads that cross on multiple levels are stored in the intermediate data.

In step ST1, the map linking unit 54 determines whether the cuboid areas P contain the navigation map node N. Incidentally, the altitude is set for the navigation map node N, and the altitudinal range is set for the cuboid areas P. Accordingly, in step ST1, when one cuboid area P contains the navigation map node N in consideration of altitude, the map linking unit 54 extracts the one cuboid area P as the reference cuboid area Pc.

Accordingly, for example, as shown in FIG. 6A, when the navigation map node N is arranged on the upper road, the map linking unit 54 determines that the navigation map node N is contained in the cuboid area P (see a solid square in FIG. 6B) centered on the lane node C of the upper road, but does not determine that the navigation map node N is contained in the cuboid area P (see a two-dot chain square in FIG. 6B) centered on the lane node C on the lower road. Accordingly, as is understood by comparing FIGS. 6B and 7A, at the point where the two roads cross on multiple levels, only the cuboid area P of the upper road is extracted as the reference cuboid area Pc.

Accordingly, the map linking unit 54 acquires (identifies) the route of the intermediate data such that the route passes through the upper road in step ST2, and acquires the route S on the high-precision map so as to pass through the upper road at the point where the roads cross on multiple levels in step ST3. Accordingly, even if the route R determined by the navigation device 11 passes through the multi-level crossing roads, it is possible to substantially determine which one of the multi-level crossing roads the route R passes through based on the altitude. Accordingly, it is possible to more accurately acquire the route S on the high-precision map as compared with a case where the altitude is not set for the navigation map node N and the altitudinal range is not set for the cuboid areas P.

In step ST1, it is possible to substantially extract the lane nodes C whose latitude, longitude and altitude match the latitude, longitude and altitude of the navigation map nodes N respectively by extracting the cuboid areas P that contain the navigation map nodes N. In this way, by using the cuboid areas P, it is possible to extract the lane nodes C that match the navigation map nodes N even if the navigation map nodes N do not completely match the lane nodes C.

In the present embodiment, the cuboid areas P are used for extracting the lane nodes C that match the navigation map nodes N. However, the areas for extracting the lane nodes C that match the navigation map nodes N may be areas in any shape (for example, a spherical shape) as long as each area contains the lane node C in the substantial center thereof. However, by making the areas cuboid as described in the present embodiment, each area can be defined by a prescribed longitudinal range, latitudinal range, and altitudinal range, so that it is possible to easily set the areas for extracting the lane nodes C that match the navigation map nodes N.

Further, in the present embodiment, the altitude length of each cuboid area P is set to be smaller than the altitude difference between two roads crossing on multiple levels. Accordingly, it is possible to reliably determine which one of the multi-level crossing roads the route R is passing through. Thus, even if the route R determined by the navigation device 11 passes through the multi-level crossing roads, it is possible to more appropriately acquire the route S on the high-precision map that matches the route R.

### The Second Embodiment

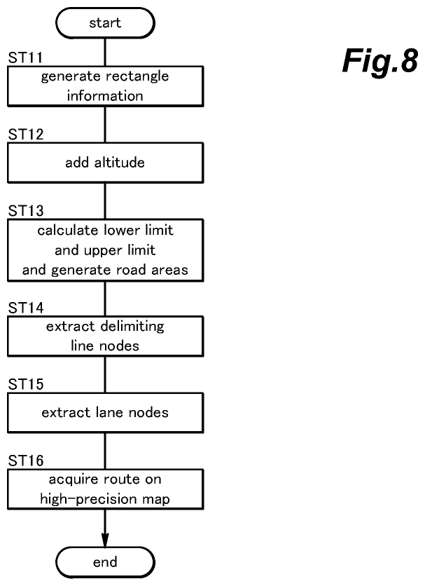

A linking process (a route data conversion process) according to a second embodiment is similar to the linking process according to the first embodiment as the route R is converted into the route S on the high-precision map in consideration of information on the altitude, but the former differs from the latter in the process itself. In the following, the route data conversion process according to the second embodiment will be described with reference to a flowchart shown in FIG. 8.

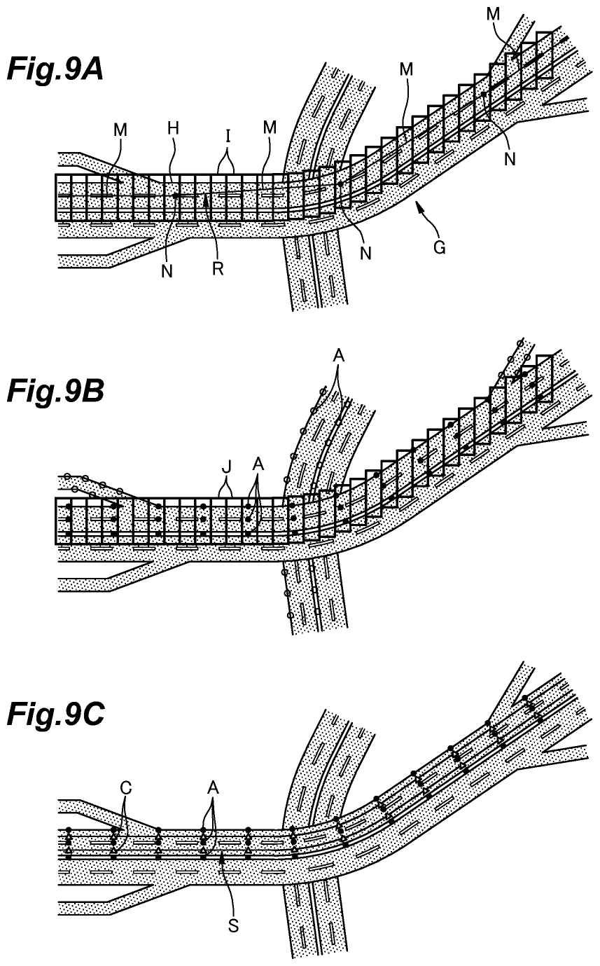

In step ST11, the map linking unit 54 acquires, from the navigation device 11, information on the route R determined by the navigation device 11 and the image data G corresponding to the determined route R. The map linking unit 54 extracts boundaries H of the roadway through which the navigation map links M passes by superimposing the navigation map nodes N and the navigation map links M corresponding to the route R on the image data G. Incidentally, the above roadway consists of all lanes arranged on one side of a median strip and in the same travel direction, and the boundaries H correspond to both edges of the all lanes in the same travel direction. Next, the map linkage unit 54 generates rectangle information in which a plurality of rectangles I indicating the latitudinal range and longitudinal range are arranged so as to cover the roadway through which the route R passes by using the extracted boundaries H (see thick lines in FIG. 9A). At this time, the map linking unit 54 may generate the rectangle information by first setting the rectangles I centered on the navigation map nodes N and then arranging other rectangles I between the set rectangles I such that the other match the boundaries H of the roadway. Accordingly, the rectangles I are set so as to contain the navigation map nodes N and the navigation map links M. The rectangle information includes ID indicating each rectangle I and the latitudinal range and longitudinal range indicated by the corresponding rectangle I. Upon completing the generation of the rectangle information, the map linking unit 54 executes step ST12.

In step ST12, the map linking unit 54 estimates the altitude of each rectangle I based on the altitude of the corresponding navigation map node N, and adds the altitude of each rectangle I to the rectangle information. More specifically, the map linking unit 54 sets the altitude of the navigation map node N with respect to each rectangle I that contains the navigation map node N, and then inserts (adds) the altitude of each rectangle I arranged therebetween into the rectangle information. Upon completing addition of the altitude to the rectangle information with respect to each rectangle I, the map linking unit 54 executes step ST13.

In step ST13, the map linking unit 54 calculates the lower limit of the altitude by subtracting half of a prescribed value (altitudinal length) from the corresponding altitude with respect to each rectangle I whose altitude is added in step ST12, and calculates the upper limit of the altitude by adding half of the prescribed value (altitudinal length) to the corresponding altitude with respect to each rectangle I. The altitudinal length is set to be smaller than the altitudinal difference between the roads that cross on multiple levels. When completing the calculation of the upper limit and the lower limit of the altitude with respect to all the rectangles I, the map linking unit 54 generates road areas J and then executes step ST14. Each road area J is arranged within a latitudinal range and longitudinal range indicated by each rectangle I, and the altitude of the road area J is equal to or less than the upper limit of the altitude corresponding to the rectangle I and equal to or more than the lower limit thereof.

In step ST14, the map linking unit 54 extracts (acquires) the delimiting line nodes A (see black circles in FIG. 9B) on the high-precision map contained in the road areas J generated (acquired) in step ST13. In the present embodiment, the size of each rectangle I (each road area J) is set such that the delimiting line nodes A that define both ends of the lane is extracted therefrom. When completing the acquisition of the delimiting line nodes A, the map linking unit 54 executes step ST15.

In step ST15, the map linking unit 54 extracts (acquires) the lane nodes C (see white triangles in FIG. 9C) arranged between the delimiting line nodes A. Upon completing the extraction, the map linking unit 54 executes step ST16.

In step ST16, the map linking unit 54 acquires the route S on the high-precision map by connecting the lane nodes C extracted in step ST15 by the lane links D (see a solid line in FIG. 9C). Upon completing the acquisition of the route S on the high-precision map, the map linking unit 54 ends the linking process.

Next, the effect of the linking process executed by the map position identifying unit 32 (map linking unit 54) will be described. The map linking unit 54 generates the rectangle information such that the rectangle information contains the navigation map nodes N and the navigation map links M by superimposing the navigation map nodes N and the navigation map links M on the image data G showing the plan view of the road (step ST11). Next, the map linking unit 54 calculates the altitude of each rectangle I by inserting the altitude of the navigation map nodes N into the rectangle information, thereby generating the road areas J (step ST12 and step ST13). After that, the map linking unit 54 acquires the delimiting line nodes A contained in the road areas J (step ST14), and acquires the lane nodes C based on the acquired delimiting line nodes A (step ST15: an extracting step). After that, the map linking unit 54 acquires the route S on the high-precision map by connecting the lane nodes C (step ST16: a connecting step).

In this way, the map linking unit 54 generates the rectangles I such that the rectangles I contain the navigation map nodes N and the navigation map links M, and calculates the altitude of the rectangles I by insertion into the navigation map nodes N. Accordingly, in ST15, it is possible to extract the lane nodes C whose latitude, longitude and altitude match the latitude, longitude and altitude of the navigation map nodes N by acquiring the delimiting line nodes A contained in the rectangles I. Accordingly, like the first embodiment, even if the route R determined by the navigation device 11 passes through the multi-level crossing roads, it is possible to substantially determine which one of the multi-level crossing roads the route R passes through based on the altitude, so that an appropriate route S on the high-precision map can be acquired.

The rectangles I are arranged so as to match a road shape based on the image data G showing the plan view of the road (step ST11), so that the delimiting line nodes A and the delimiting line links B that match the road shape can be extracted (step ST14). Accordingly, it is possible to acquire the route S on the high-precision map that matches the route R on the navigation map in consideration of the road shape.

The delimiting line nodes A and the delimiting line links B contained in the road areas J are extracted (step ST14) and thus the route S on the high-precision map is acquired (steps ST14 and ST15). Accordingly, the route S on the high-precision map can be acquired in more consideration of the road shape as compared with a case where the lane nodes C and the lane links D contained in the road areas J are extracted and thus the route S on the high-precision map is acquired. In the present embodiment, two delimiting line nodes A arranged at both ends of the lane are extracted (step ST14), and the lane nodes C arranged therebetween can be easily extracted (step ST15). Furthermore, as the road areas J are used for the extraction of the delimiting line nodes A (step ST14), like the first embodiment, the delimiting line nodes A can be extracted even if the navigation map does not completely match the high-precision map.

Concrete embodiments of the present invention have been described in the foregoing, but the present invention should not be limited by the foregoing embodiments and various modifications and alterations are possible within the scope of the present invention.

In the first embodiment, the altitude corresponding to the navigation map nodes N and the lane nodes C on the high-precision map are included in the navigation map and the dynamic map respectively. However, the present invention is not limited to this embodiment. In a case where the multi-level crossing roads are not considered, the navigation map nodes N and the lane nodes C may be defined by the latitude and longitude respectively. In this case, the map position identifying unit 32 (the map linking unit 54) may determine whether each rectangle I centered on the lane node C contains the navigation map node N in the plan view, extract the lane node C in the center of the rectangle I that contains the navigation map node N, and acquire the route S on the high-precision map corresponding to the route R on the navigation map by connecting the lane nodes C.

In the second embodiment, the boundaries H are defined as both edges of the lanes in the same traveling direction. However, the present invention is not limited to this embodiment. For example, the boundaries H may be defined as both edges of all the lanes, both edges of the vehicle, or both edges of the road.

1. A route data conversion method for acquiring a second route on a second map that matches a first route on a first map,
the first route being expressed as route nodes and route links, the route nodes being defined by latitude, longitude, and altitude, the route links connecting the route nodes,
the second map including a lane expressed as lane nodes and lane links, the lane nodes being defined by the latitude, longitude, and altitude, the lane links connecting the lane nodes,
the route data conversion method comprising:
extracting the lane nodes whose latitude, longitude, and altitude match the latitude, longitude, and altitude of the route nodes respectively; and
acquiring the second route by connecting the extracted lane nodes by the lane links.

2. The route data conversion method according to claim 1, wherein in the step of extracting the lane nodes, extracting areas containing the route nodes from an intermediate map including the areas centered on the lane nodes and area links connecting the areas, thereby extracting the lane nodes whose latitude, longitude, and altitude match the latitude, longitude, and altitude of the route nodes respectively.

3. The route data conversion method according to claim 2, wherein each of the areas is defined by a prescribed longitudinal range, latitudinal range, and altitudinal range centered on the lane node.

4. The route data conversion method according to claim 2, wherein an altitudinal length of each of the areas is smaller than an altitudinal difference between two roads crossing on multiple levels.

5. The route data conversion method according to claim 1, wherein the first map includes image data showing a plan view of a road, and
in the step of extracting the lane nodes,
acquiring road areas based on the image data and the route nodes such that the road areas contain the route nodes and match not only a shape of the road through which the first route passes but also the altitude of the route nodes in the plan view, and
extracting the lane nodes that match the road areas.

6. The route data conversion method according to claim 5, wherein the second map includes a delimiting line indicating a side edge on one lateral side of the lane,
the delimiting line is expressed as delimiting line nodes defined by the latitude, longitude, and altitude, and
in the step of extracting the lane nodes,
extracting a boundary of a roadway corresponding to the first route from the image data and setting each of the road areas defined by a prescribed latitudinal range, longitudinal range, and altitudinal range,
extracting the delimiting line nodes arranged inside the road areas, and
extracting the lane nodes that match the route nodes by using the extracted delimiting line nodes.

7. The route data conversion method according to claim 6, wherein in the step of extracting the lane nodes, extracting the lane nodes arranged between the extracted delimiting line nodes and the delimiting line nodes indicating another side edge of the lane opposite to the extracted delimiting line nodes, thereby extracting the lane nodes that match the route nodes.

8. A non-transitory computer-readable storage medium, comprising a route data conversion program for acquiring a second route on a second map that matches a first route on a first map,
the first route being expressed as route nodes and route links, the route nodes being defined by latitude, longitude, and altitude, the route links connecting the route nodes,
the second map including a lane expressed as lane nodes and lane links, the lane nodes being defined by the latitude, longitude, and altitude, the lane links connecting the lane nodes,
wherein the route data conversion program, when executed by a processor, executes a route data conversion method comprising:
extracting the lane nodes whose latitude, longitude, and altitude match the latitude, longitude, and altitude of the route nodes respectively; and
acquiring the second route by connecting the extracted lane nodes.

9. The storage medium according to claim 8, wherein in the step of extracting the lane nodes, extracting areas containing the route nodes from an intermediate map including the areas centered on the lane nodes and area links connecting the areas, thereby extracting the lane nodes whose latitude, longitude, and altitude match the latitude, longitude, and altitude of the route nodes respectively.

10. The storage medium according to claim 8, wherein the first map includes image data showing a plan view of a road, and
in the step of extracting the lane nodes,
acquiring road areas based on the image data and the route nodes such that the road areas contain the route nodes in the plan view and match not only a shape of the road through which the first route passes but also the altitude of the route nodes, and
extracting the lane nodes that match the road areas.

11. A route data conversion device for acquiring a second route on a second map that matches a first route on a first map,
the first route being expressed as route nodes and route links, the route nodes being defined by latitude, longitude, and altitude, the route links connecting the route nodes,
the second map including a lane expressed as lane nodes and lane links, the lane nodes being defined by the latitude, longitude, and altitude, the lane links connecting the lane nodes,
wherein the route data conversion device comprising a processor configured to:
extract the lane nodes whose latitude, longitude, and altitude match the latitude, longitude, and altitude of the route nodes respectively; and
acquire the second route by connecting the extracted lane nodes.

12. The route data conversion device according to claim 11, wherein in the step of extracting the lane nodes, extracting areas containing the route nodes from an intermediate map including the areas centered on the lane nodes and area links connecting the areas, thereby extracting the lane nodes whose latitude, longitude, and altitude match the latitude, longitude, and altitude of the route nodes respectively.

13. The route data conversion device according to claim 11, wherein the first map includes image data showing a plan view of a road, and
in the step of extracting the lane nodes,
acquiring road areas based on the image data and the route nodes such that the road areas contain the route nodes in the plan view and match not only a shape of the road through which the first route passes but also the altitude of the route nodes, and
extracting the lane nodes that match the road areas.
